(19) United States
(12) Patent Application Publication
(10) Pub. No.: US 2006/0125617 A1
(43) Pub. Date: Jun. 15, 2006

(54) Method and apparatus for anticipated brake light activation

(76) Inventor: Benjamin Zimmermann, Moreno Valley, CA (US)

Correspondence Address: Jack I. J'maev, 187 W. Orangethorpe Ave., Placentia, CA, 92870, US

(21) Appl. No.: 11/011,311

(22) Filed: Dec. 13, 2004

(51) Int. Cl. B60Q 1/50; B60Q 1/44

(52) U.S. Cl. 340/467; 340/479

(57) ABSTRACT

A method and apparatus for activating a brake light by detecting when a user of an automobile has relaxed pressure on an accelerator pedal and then activating the brake light when the pressure on the accelerator pedal has been relaxed.

### BACKGROUND

Modernly, automobiles have brake light indicators that warn other vehicles when a driver of an automobile begins to slow down. The indicator works by detecting actuation of a brake pedal. This can be done in several ways. One way that this is accomplished is by disposing an electrical switch so as to detect when the brake pedal is depressed. The electrical switch then activates a brake light when the brake pedal is depressed. Another way that this is accomplished is by disposing a pressure sensitive switch so as to sense activity in the hydraulic system that actually transmits force to braking mechanisms installed at the wheels of a car. For example, such a pressure switch is often installed at a master hydraulic cylinder. When a brake pedal is depressed, the hydraulic cylinder increases the pressure in a hydraulic line that feeds hydraulic fluid to at least one of the wheels of the car. The pressure sensor will then activate a brake light when it senses the increase in hydraulic pressure. Many other techniques can be used to determine when a brake pedal is depressed. Once it is determined that the brake pedal has been depressed, a brake light can be activated.

With an ever increasing volume of traffic on the roads today, it is clear that traffic jams are only going to get worse. One of the problems with the stop-n-go traffic that results on congested streets is that of a rear-end collision. Rear end collisions are difficult to avoid in bumper-to-bumper traffic because most motorists fail to observe minimum safe distances between their cars and the cars in front of them. It really, however, isn't the drivers fault. Because of the amount of congestion, there simply isn't enough room to actually maintain a safe following distance.

In this context, the use of a brake pedal actuation detector as a basis from activating a brake light is simply ineffective. Because of the short durations between acceleration and braking, a motorist may not have enough time to avoid a rear end collision because the brake light of the car in front of her was not perceived and acted upon as quickly as needed. What is needed is to provide a motorist that is following closely behind another car with an advance warning that the driver in the car in front of him is about to stop.

### SUMMARY

A method and apparatus for activating a brake light by detecting when a user of an automobile has relaxed pressure on an accelerator pedal and then activating the brake light when the pressure on the accelerator pedal has been relaxed.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram data depicts one example method for activating a brake light;

FIG. 2 is a flow diagram that depicts an alternative example method for detecting when a user has relaxed the application of pressure upon an accelerator pedal;

FIG. 3 is a flow diagram that depicts an alternative method for detecting the relaxation of pressure upon an accelerator pedal;

FIG. 4 is a flow diagram that depicts alternative method for detecting the relaxation of pressure upon an accelerator pedal;

FIG. 5 is a flow diagram that depicts another example variation of a method for detecting when a user has relaxed application of pressure upon an accelerator pedal;

FIG. 6 is a flow diagram that depicts one variation of the present method for activating a brake light;

FIG. 7 is a pictorial diagram that depicts several alternative embodiments of a brake light activation unit;

FIGS. 7 and 8A collectively form a pictorial diagram that depicts one alternative embodiment of a pressure detection unit capable of sensing stress in a pedal support arm;

FIGS. 7 and 8B collectively form a pictorial diagram that depicts one alternative embodiment of a pressure detection unit capable of sensing a rate of an accelerator pedal's movement;

FIGS. 7 and 8C collectively form a pictorial diagram that depicts one alternative embodiment of a pressure detection unit capable of sensing a position of an accelerator pedal relative to a support arm for same;

FIG. 9 is a block diagram that depicts one alternative embodiment of a brake light activation circuit;

FIG. 10 is a block diagram that depicts one alternative embodiment of a brake light activation unit which further comprises a cancellation timer;

### DETAILED DESCRIPTION

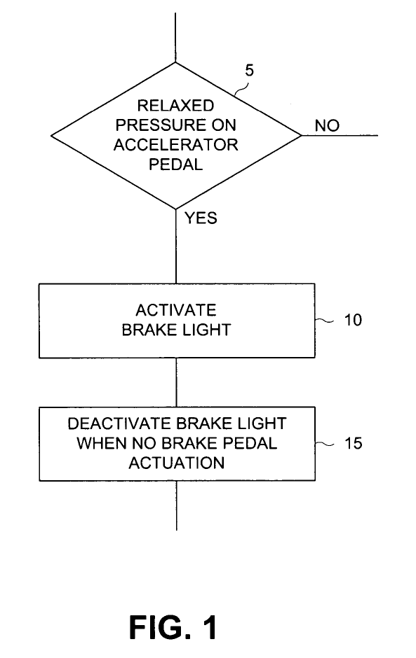

FIG. 1 is a flow diagram data depicts one example method for activating a brake light. According to this example method, a brake light is activated by detecting when pressure on an accelerator pedal is relaxed (step 5). When pressure on the accelerator pedal is relaxed, the brake light of the vehicle is activated (step 10). It should be appreciated that, according to one variation of the present method, the brake light is deactivated (step 15) when a user has not actuated a brake pedal within a pre-established period of time after relaxing pressure on the accelerator pedal. In this manner, the brake lights of the vehicle can be activated in anticipation of a user's application of braking force in order to slow the vehicle.

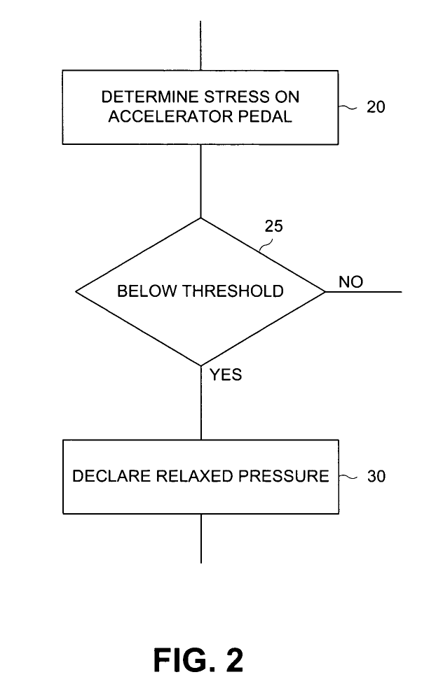

FIG. 2 is a flow diagram that depicts an alternative example method for detecting when a user has relaxed the application of pressure upon an accelerator pedal. According to this example variation of the present method, detecting when a user has relaxed the application of pressure upon an accelerator pedal is accomplished by determining the level of stress present in an accelerator pedal support arm (step 20). It should be appreciated that when the level of stress present in the support arm of an accelerator pedal falls below a pre-establish threshold (step 25), is possible to declare that the pressure applied to the Excel rate or pedal has been relaxed (step 30).

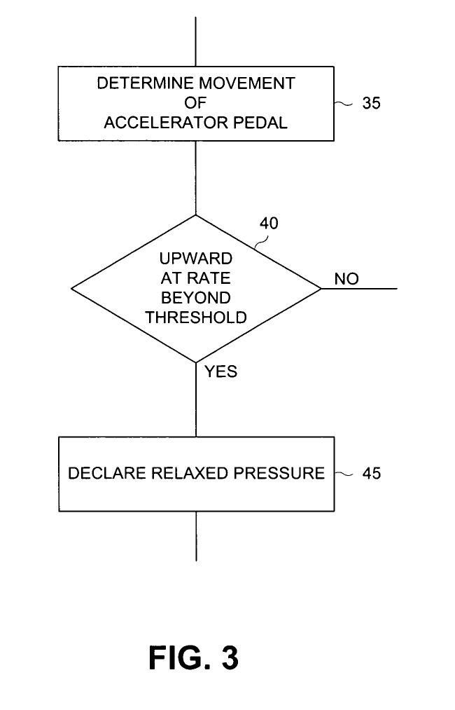

FIG. 3 is a flow diagram that depicts an alternative method for detecting the relaxation of pressure upon an accelerator pedal. According to this very sure the present method, detection of a relaxed pressure upon an accelerator pedal is a calm pushed by determining the movement of an accelerator pedal (step 35). By detecting the movement of the accelerator pedal, an upward movement of the accelerator pedal beyond a pre-established rate threshold (step 40) results in a declaration that the pressure applied to the accelerator pedal has been relaxed (step 45).

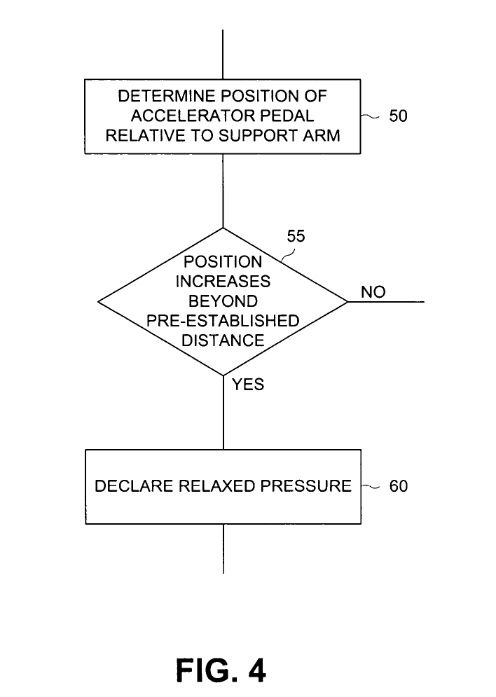

FIG. 4 is a flow diagram that depicts alternative method for detecting the relaxation of pressure upon an accelerator pedal. It should be appreciated that many accelerator pedals are pivotally attached your support arm. Accordingly, there may be a varying distance between the accelerator pedal and the support arm. According to this alternative method, detecting relaxation of pressure upon an accelerator pedal is accomplished by determining the position of an accelerator pedal relative to a support arm (step 50). When the position of the accelerator pedal relative to the support arm increases or decreases beyond a pre-establish distance (step 55), the present method provides for declaring that pressure upon the accelerator pedal has been relaxed (step 60).

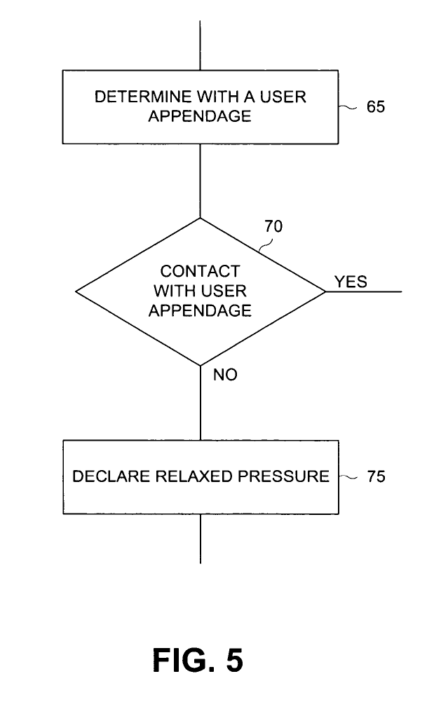

FIG. 5 is a flow diagram that depicts another example variation of a method for detecting when a user has relaxed application of pressure upon an accelerator pedal. According to this variation of the present method, detecting when a user has relaxed the application of pressure upon an accelerator pedal is a calm pushed by detecting contact with a user's appendage (step 65). It should be appreciated that in order to apply pressure to an accelerator pedal a user typically is required to apply pressure with an appendage (e.g. a user's foot). In this situation, when contact with the user's appendage has ceased (step 70), the present method provides for declaring that the pressure applied to the accelerator pedal has been relaxed (step 75).

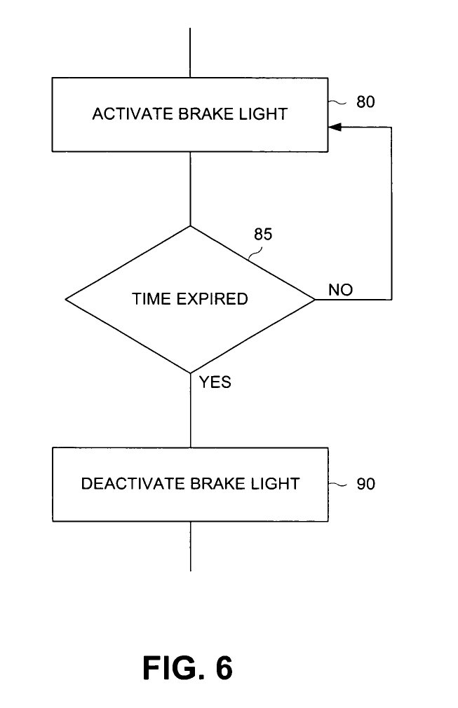

FIG. 6 is a flow diagram that depicts one variation of the present method for activating a brake light. According to this variation of the present method, a brake light is activated by activating the brake light (step 80) and then waiting for a pre-establish interval of time to expire (step 85). When the pre-establish interval of time has expired, the brake light is deactivated (step 20). It should be appreciated that, according to this variation of the present method, the brake light is activated for short interval of time after detection that the amount of pressure applied to the accelerator pedal has been relaxed.

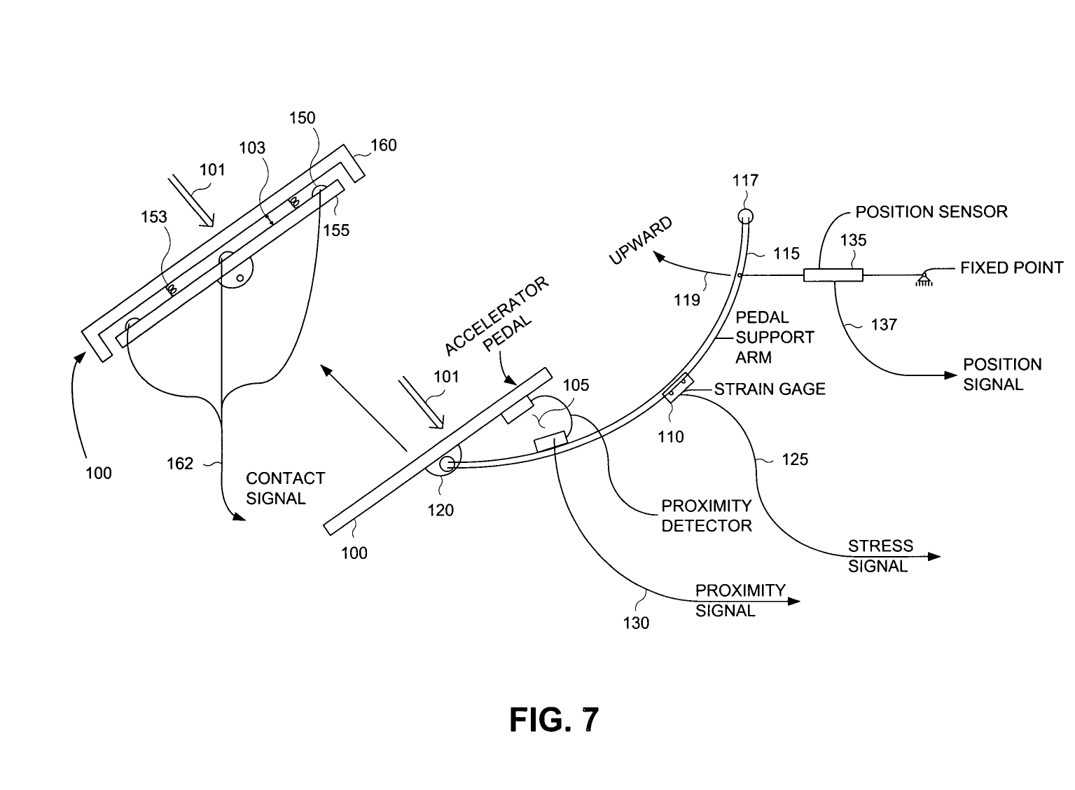

FIG. 7 is a pictorial diagram that depicts several alternative embodiments of a brake light activation unit. According to one alternative embodiment, a brake light activation unit comprises a pressure detection unit which is disposed to detect relaxation of force 101 applied to accelerator pedal 100 and is further capable of generating a brake light signal according to the pressure relaxation signal.

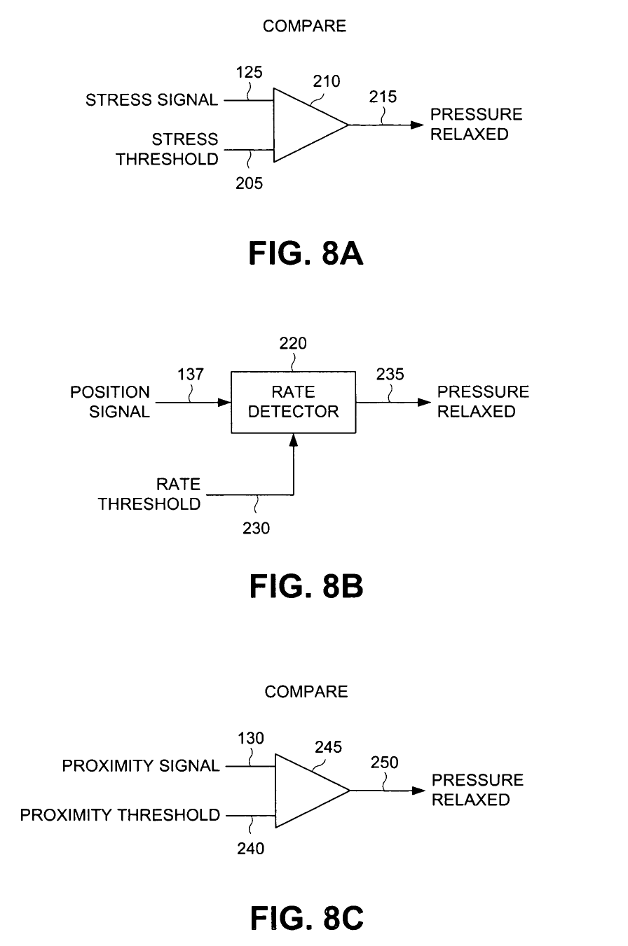

FIGS. 7 and 8A collectively form a pictorial diagram that depicts one alternative embodiment of a pressure detection unit capable of sensing stress in a pedal support arm. According to this alternative embodiment, a pressure detection unit comprises a strain gauge 110 and a comparator 210. It should be appreciated that the strain gauge 110 is disposed to sense the amount of stress present in a pedal support arm 115. The comparator 210 receives a stress signal 125 is generated by the strain gauge 110 and represents a stress level exhibited by the pedal support arm 115. The comparator 210 compares to the level of the stress signal 125 against a stress threshold 205. It should be appreciated that the stress threshold 205 is a pre-established value, at least according to one alternative embodiment. The comparator 210 generates a pressure relaxed signal 215 when the stress signal 125 is greater than or equal to the stress threshold 205.

FIGS. 7 and 8B collectively form a pictorial diagram that depicts one alternative embodiment of a pressure detection unit capable of sensing a rate of an accelerator pedal's movement. According to one alternative embodiment, a pressure detection unit comprises a position sensor 135 and a rate detector 220. It should be appreciated that the position sensor 135 is disposed to sense the position of a pedal support arm 115 relative to a top pivotal attachment 117. As the pedal support arm 115 pivots about the top pivotal attachment 117, the position sensor 135 generates a position signal 137 according to the angular position of the pedal support arm 115 relative to the top pivotal attachment 117. Accordingly, the rate detector 220 receives the position signal 137 and a pre-established rate threshold 230. When the rate detector 220 determines that the position signal 137 is changing at a rate that exceeds the rate threshold 230, the rate detector 220 generates a pressure relaxed signal 235. It should be appreciated that the rate detector 220 is sensitive to the direction of movement indicated by the position signal 137. Accordingly, the rate detector 220 generates a pressure relaxed signal 235 when the rate signal 137 indicates that the panel support arm 115 is moving in an upward direction relative to a user. In this figure, the upward direction 119 represents a clockwise rotation about the top pivotal attachment 117.

FIGS. 7 and 8C collectively form a pictorial diagram that depicts one alternative embodiment of a pressure detection unit capable of sensing a position of an accelerator pedal relative to a support arm for same. According to this alternative embodiment, a pressure detection unit comprises a proximity detector 105. The proximity detector 105 is disposed to sense the position of an accelerator pedal 100 relative to the pedal support arm 115. It should be appreciated that, according to some embodiments, the accelerator pedal 100 is pivotally attached 120 to a lower end of a pedal support arm 115. This type of pivotal attachment to the lower end of a pedal support arm is generally provided to improve the comfort of a user that is depressing the pedal with an appendage. It should be further appreciated that when the accelerator pedal is depressing by the application of a force 101 the accelerator pedal 100 will pivot about a lower pivotal attachment 120. It should further be appreciated that when force 101 is applied to the accelerator pedal one or another end of the accelerator pedal 100 will move either farther away or closer towards the pedal support arm 115. Accordingly, when force 101 is removed from the accelerator pedal, the distance from one or another end of the accelerator pedal 100 to the support arm 115 will change. It should be appreciated that this distance will increase in some illustrative use cases and will decrease in other illustrative use cases and the determination as to whether or not the distance will increase or decrease is dependent upon the structural formation of the accelerator pedal 100, the positioning of the lower pivotal attachment 120 and the structural formation of the pedal support arm 119. According to one alternative embodiment, the comparator 245 detects when the proximity single 130 is greater than or equal to a three-established value, which in this embodiment is called a proximity threshold 240. It yet another alternative embodiment, the comparator 245 detects when the proximity single 130 is less than or equal to a three-established value, which is also called a proximity threshold 240. Upon detection, either of these embodiments of a comparator 245 generates a pressure relaxed signal 250.

FIG. 7 also depicts one alternative embodiment of a pressure detection unit capable of sensing contact of a user's appendage with an accelerator pedal. According to this alternative embodiment, the pressure detection unit comprises a contact detector. According to one alternative illustrative embodiment, the contact detector comprises one or more contact sensors 150, which can comprise momentary contact switches. This embodiment, the accelerator pedal 100 comprises a pedal base 155 and a pedal cover 160. Typically, the pedal cover 160 is disposed above the pedal base 155. As illustrated in figure, one alternative embodiment of the pedal cover 160 forms a clamshell wherein the pedal base 155 enters a cavity formed by the clamshell. It should be appreciated that the one or more contact sensors 150 are disposed to sense when a distance 103 between the pedal cover 160 and the pedal base 150 is reduced as a result of the application of force 101 upon the pedal cover 160. It should be further appreciated that one alternative embodiment further comprises one or more hold-offsprings 153, which are disposed to restore a minimum relaxed distance between the pedal cover 160 and the pedal base 155. This minimum relaxed distance is maintained by the hold-offsprings 153 in the absence of an applied force 101 which may otherwise the incident upon the pedal cover 160. Typically, the contact detector, which in one alternative embodiment comprises a contact switch, will generate the contact signal 162. It should further be appreciated that the contact signal 162 is analogous to a pressure relaxed signal and may be used as an indication that the pressure applied to accelerator pedal has been relaxed.

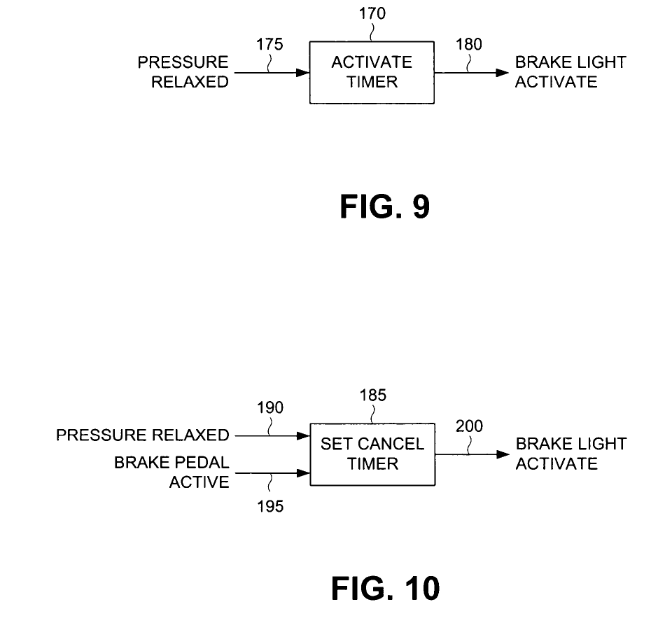

FIG. 9 is a block diagram that depicts one alternative embodiment of a brake light activation circuit. According to this alternative embodiment, he brake light activation circuit comprises an activation timer 170. In this alternative embodiment, the activation timer 170 receives a pressure relaxed signal 175 from one of various alternative embodiment of a pressure detection unit. Upon receiving the pressure relaxed signal 175, the activation timer 170 generates a brake light activation single 180. The activation timer 170 maintains the brake light activation single 180 pre-established period of time. Accordingly, a brake light is activated on a momentary basis is the pressure relaxed signal 175 is received. It should further be appreciated that the brake light can be further activated once a user actuates a brake pedal.

FIG. 10 is a block diagram that depicts one alternative embodiment of a brake light activation unit which further comprises a cancellation timer. According to this alternative embodiment, he brake light activation unit further comprises a cancellation timer 185. In operation, they cancellation time 185 receives a pressure relaxed signal from one of numerous alternative embodiments of a pressure detection unit. The cancellation timer 185 to this alternative embodiment of a brake light activation unit generates a brake light activation single 200 when a pressure relaxed signal is received. The cancellation timer 185 will deactivate the brake light activation single 200 unless a brake pedal activation single 195 is received within a pre-established period of time after the pressure relaxed signal 190 is received. Accordingly, unless a user actuates a brake pedal within a prescribed period of time after having released pressure from an accelerator pedal, the cancellation timer 185 will extinguish an activated brake light.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for activating a brake light comprising:
detecting when a user has relaxed the application of pressure on an accelerator pedal; and
activating a brake light when the pressure on the accelerator pedal has been relaxed.

2. The method of claim 1 wherein detecting that a user has relaxed the application of pressure comprises:
determining the level of stress in an accelerator pedal support arm; and
declaring that a user has relaxed the application of pressure on the accelerator pedal when the determined level of stress falls below a pre-established threshold.

3. The method of claim 1 wherein detecting that a user has relaxed the application of pressure comprises:
determining a movement of an accelerator pedal; and
declaring that a user has relaxed the application of pressure on the accelerator pedal when the position of the accelerator pedal changes upward at a minimum pre-established rate.

4. The method of claim 1 wherein detecting that a user has relaxed the application of pressure comprises:
determining a position of an accelerator pedal relative to a support arm; and
declaring that a user has relaxed the application of pressure on the accelerator pedal when the position of the accelerator pedal relative to the support arm increases beyond a pre-established distance.

5. The method of claim 1 wherein detecting that a user has relaxed the application of pressure comprises:
detecting contact of a user's appendage upon an accelerator pedal; and
declaring that a user has relaxed the application of pressure on the accelerator pedal when the user's appendage is no longer in contact with the accelerator pedal.

6. The method of claim 1 wherein activating a brake light comprises activating a brake light for a pre-established interval of time when the pressure on the accelerator pedal has been relaxed.

7. The method of claim 1 further comprising deactivating the break light when a user has not depressed a brake pedal within a pre-established amount of time.

8. A brake light activation unit comprising:
pressure detection unit disposed to detect relaxation of force applied to an accelerator pedal and further capable of generating a pressure relaxation signal; and
brake light activation circuit capable of generating a brake light signal according to the pressure relaxation signal.

9. The brake light activation unit of claim 8 wherein the pressure detection unit comprises:
strain gage disposed to sense an amount of stress in the support arm for an accelerator pedal that is capable of generating a stress signal according to a stress level experienced by said support arm; and
comparator capable of generating a pressure relaxed indicator when the stress signal is less than or equal to a pre-established value.

10. The brake light activation unit of claim 8 wherein the pressure detection unit comprises:
position sensor disposed to sense a position is a support arm for an accelerator pedal capable of generating a position signal according to a sensed position for said support arm; and
rate detector capable of generating a pressure relaxed indicator when the position signal is changing at a rate that is greater than or equal to a pre-established value.

11. The brake light activation unit of claim 8 wherein the pressure detection unit comprises:
position sensor disposed to sense a position of an accelerator pedal relative to a support arm for said accelerator pedal capable of generating a position signal according to a sensed relative position of said accelerator pedal to said support arm; and
comparator capable of generating a pressure relaxed indicator when the position signal is greater than or equal to a pre-established value.

12. The brake light activation unit of claim 8 wherein the pressure detection unit comprises:
position sensor disposed to sense a position of an accelerator pedal relative to a support arm for said accelerator pedal capable of generating a position signal according to a sensed relative position of said accelerator pedal to said support arm; and
comparator capable of generating a pressure relaxed indicator when the position signal is less than or equal to a pre-established value.

13. The brake light activation unit of claim 8 wherein the pressure detection unit comprises:
contact detector disposed to sense contact of a user's appendage with an accelerator pedal capable of generating a pressure relaxed indicator when the contact signal is inactive.

14. The brake light activation unit of claim 8 wherein the brake light activation circuit comprises timer capable of generating a brake light activation signal for a pre-established period of time when a pressure relaxed signal is received.

15. The brake light activation unit of claim 8 further comprising a cancel timer capable of generating a brake light activation signal when a pressure relaxed signal is received and is further capable of deactivating the brake light activation signal when a brake pedal active signal is not received within a pre-established period of time after the pressure relaxed signal is received.
